(19) United States
(12) Patent Application Publication
(10) Pub. No.: US 2025/0370382 A1
(43) Pub. Date: Dec. 4, 2025

(54) HEATING SYSTEM AND IMAGE FORMING APPARATUS

(71) Applicant: FUJIFILM Business Innovation Corp., Tokyo (JP)

(72) Inventor: Tatsuro MATSUOKA, Kanagawa (JP)

(73) Assignee: FUJIFILM Business Innovation Corp., Tokyo (JP)

(21) Appl. No.: 18/892,585

(22) Filed: Sep. 23, 2024

(30) Foreign Application Priority Data
Jun. 4, 2024 (JP) 2024-090761

(51) Int. Cl. G03G 15/20; G03G 21/20

(52) U.S. Cl. CPC G03G 15/2025; G03G 15/2064; G03G 21/206

(57) ABSTRACT

A heating system includes a first rotating body that is heated by a heating unit and is rotated, a second rotating body that is rotated while being in contact with an outer peripheral surface of the first rotating body to form a passage portion through which an object to be heated passes, a cooling device that causes air to flow along a path, which allows the air to pass in contact with an outer peripheral surface of the second rotating body, to cool the outer peripheral surface, and a support member that supports a cleaning member, which is to be in contact with the outer peripheral surface of the second rotating body to clean the outer peripheral surface, to allow the cleaning member to be in contact with and separated from the outer peripheral surface and includes a blocking portion entering and blocking the path in a case where the cleaning member is in contact with the outer peripheral surface, in which the blocking portion of the support member is provided with a vent hole that is connected to the path.

### CROSS-REFERENCE TO RELATED APPLICATIONS

This application is based on and claims priority under 35 USC 119 from Japanese Patent Application No. 2024-090761 filed Jun. 4, 2024.

### BACKGROUND

### (i) Technical Field

The present invention relates to a heating system and an image forming apparatus.

### (ii) Related Art

JP2010-188676A (claim 2, and FIGS. 6 and 7) discloses a printer that changes an air path for cooling depending on a component required to be cooled during printing, during standby, or during power shutdown.

JP2016-71131A (Amended claim 1, and FIGS. 2 and 3) discloses a fixing device including a first rotating body and a second rotating body that form a nip portion for fixing, a detection unit that detects a temperature of the first rotating body, and a blower unit that blows air toward the first rotating body.

Further, JP2016-71131A (Amended claim 1, and FIGS. 2 and 3) also discloses that the fixing device includes a suppression portion provided along a circumferential direction of the first rotating body not to be in contact with the first rotating body and suppressing the flow of air blown from the blower unit to the detection unit.

Furthermore, JP2016-71131A (Amended claim 1, and FIGS. 2 and 3) also discloses that the suppression portion includes a recessed portion which is open toward a peripheral surface of the first rotating body and a partition portion which partitions the recessed portion into a plurality of spaces in a circumferential direction of the first rotating body.

### SUMMARY

There is a heating system including: a first rotating body; a second rotating body that is in contact with the first rotating body to form a passage portion for an object to be heated; a cooling device that causes air to flow along a predetermined path, which allows air to pass in contact with an outer peripheral surface of the second rotating body, to cool the second rotating body; and the like. In this heating system, a cleaning member may be made to be in contact with the outer peripheral surface of the second rotating body during cleaning to clean the outer peripheral surface of the second rotating body.

Aspects of non-limiting embodiments of the present disclosure relate to a heating system and an image forming apparatus in which a cooling device can cause air to flow into a predetermined path to cool an outer peripheral surface of a second rotating body even during the cleaning of the second rotating body.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a heating system including: a first rotating body that is heated by a heating unit and is rotated; a second rotating body that is rotated while being in contact with an outer peripheral surface of the first rotating body to form a passage portion through which an object to be heated passes; a cooling device that causes air to flow along a path, which allows the air to pass in contact with an outer peripheral surface of the second rotating body, to cool the outer peripheral surface; and a support member that supports a cleaning member, which is to be in contact with the outer peripheral surface of the second rotating body to clean the outer peripheral surface, to allow the cleaning member to be in contact with and separated from the outer peripheral surface and includes a blocking portion entering and blocking the path in a case where the cleaning member is in contact with the outer peripheral surface, in which the blocking portion of the support member is provided with a vent hole that is connected to the path.

### BRIEF DESCRIPTION OF THE DRAWINGS

Exemplary embodiment(s) of the present invention will be described in detail based on the following figures, wherein:

FIG. 1 is a schematic diagram showing an image forming apparatus according to a first exemplary embodiment;

FIG. 2 is a schematic diagram showing a heating system according to the first exemplary embodiment;

FIG. 3A is a schematic diagram showing a state where a second rotating body of the heating system is separated from a first rotating body, and FIG. 3B is a schematic diagram showing a state where the second rotating body shown in FIG. 3A is cleaned;

FIG. 4A is a schematic diagram showing a state where the second rotating body during a normal operation is cooled by air, and FIG. 4B is a schematic diagram showing a state where the second rotating body during cleaning is cooled by air;

FIG. 5A is a schematic front view showing a roller cleaning device in a partial cross section, and FIG. 5B is a schematic cross-sectional view of the roller cleaning device shown FIG. 5A taken along line Q-Q;

FIG. 6 is a schematic diagram showing a modification example of vent holes of the roller cleaning device in a partial cross section; and

FIG. 7 is a schematic diagram showing a state of a heating system of a comparative example and a peripheral portion thereof.

### DETAILED DESCRIPTION

Exemplary embodiments of the present invention will be described below.

### First Exemplary Embodiment

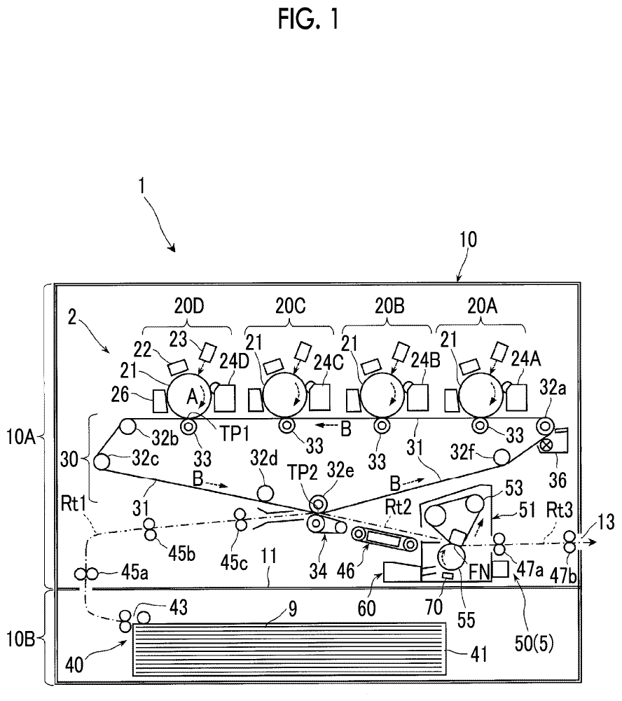

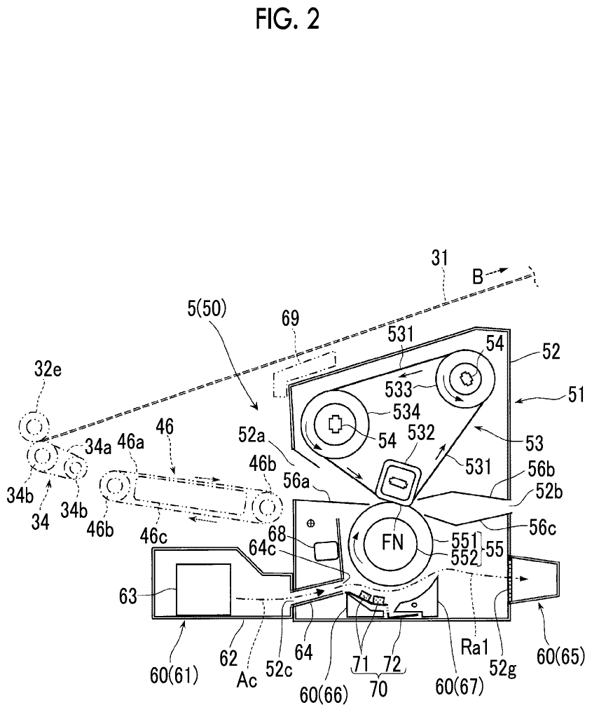

FIG. 1 is a schematic diagram showing an image forming apparatus 1 according to a first exemplary embodiment of the present invention. FIG. 2 is a schematic diagram showing a heating system according to the first exemplary embodiment of the present invention.

In the present specification and the drawings, substantially identical components are denoted by identical reference numerals. Further, the repeated description of the identical components is omitted in the present specification.

### Image Forming Apparatus

The image forming apparatus 1 according to the first exemplary embodiment is configured as, for example, a printer.

Further, an image forming unit 2, a medium feed section 40, a fixing unit 50, and the like are disposed inside a housing 10 of the image forming apparatus 1.

The housing 10 is a structure that has an internal space and is formed in a predetermined shape.

Further, for example, the housing 10 is divided into an upper housing 10A and a lower housing 10B with a partition plate 11 as a boundary. The image forming unit 2, the fixing unit 50, and the like are disposed in the upper housing 10A. The medium feed section 40 and the like are disposed in the lower housing 10B.

### Image Forming Unit

The image forming unit 2 is a part that forms an unfixed image on a recording medium 9.

The image forming unit 2 includes an imaging section 20, an intermediate transfer section 30, and a medium feed section 40.

The imaging section 20 is a part that forms an unfixed image obtained by developing a latent image corresponding to image information with a developer.

As shown in FIG. 1, the imaging section 20 of the first exemplary embodiment includes four imaging units 20A, 20B, 20C, and 20D.

The imaging units 20A, 20B, 20C, and 20D are units that employ an electrophotographic method. The imaging units 20A, 20B, 20C, and 20D form unfixed images, which are developed with developers having predetermined colors (A, B, C, and D), on photosensitive drums 21, respectively.

Examples of the predetermined colors (A, B, C, and D) include colors such as yellow, magenta, cyan, and black.

Further, in each of the imaging units 20A, 20B, 20C, and 20D, a charging device 22, an exposure device 23, a developing device 24, a drum cleaning device 26, and the like are disposed around the photosensitive drum 21.

Reference numerals of the charging device 22, the exposure device 23, and the drum cleaning device 26 are representatively shown only for the imaging unit 20D. Since the colors (A, B, C, and D) of the developers to be used are different from each other, the developing devices 24 are shown as the developing devices 24A, 24B, 24C, and 24D.

The intermediate transfer section 30 is a part that relays and transfers each of toner images, which are formed by the imaging units 20A, 20B, 20C, and 20D of the imaging section 20, onto a recording medium 9.

The intermediate transfer section 30 of the first exemplary embodiment includes an intermediate transfer belt 31, primary transfer devices 33, a secondary transfer device 34, a belt cleaning device 36, and the like.

The intermediate transfer belt 31 is an endless belt that can hold a toner image on an outer peripheral surface of the belt mainly with an electrostatic force and transport the toner image.

The intermediate transfer belt 31 is rotated while passing by the respective photosensitive drums 21 of the imaging units 20A, 20B, 20C, and 20D. Specifically, the intermediate transfer belt 31 is wound around a predetermined number of support rollers 32a, 32b, 32c, 32d, 32e, and 32f and is rotated in a direction indicated by an arrow B. Among these support rollers, the support roller 32a is a driving roller and the support roller 32e is a secondary transfer back roller.

The primary transfer device 33 is a device that primarily transfers each toner image formed on each photosensitive drum 21 onto the outer peripheral surface of the intermediate transfer belt 31. In the intermediate transfer section 30, a position where the primary transfer device 33 faces each photosensitive drum 21 with the intermediate transfer belt 31 interposed therebetween is a primary transfer position TP1.

A device using a primary transfer roller, which rotates in contact with the outer peripheral surface of the intermediate transfer belt 31 at the primary transfer position TP1, is applied as the primary transfer device 33. A predetermined primary transfer bias is supplied to the primary transfer roller from a power supply device (not shown).

The secondary transfer device 34 is a device that secondarily transfers the toner images primarily transferred to the outer peripheral surface of the intermediate transfer belt 31 onto one surface of a recording medium 9. In the intermediate transfer section 30, a position where the secondary transfer device 34 faces the support roller 32e with the intermediate transfer belt 31 interposed therebetween is a secondary transfer position TP2.

A device using a secondary transfer roller or a secondary transfer belt, which rotates in contact with the outer peripheral surface of the intermediate transfer belt 31 at the secondary transfer position TP2, is applied as the secondary transfer device 34. A predetermined secondary transfer bias is supplied to the secondary transfer roller or a roller, which supports the secondary transfer belt, from a power supply device (not shown). In the first exemplary embodiment, a device in which a secondary transfer belt 34a is rotatably supported by two support rollers 34b is employed as the secondary transfer device 34.

The medium feed section 40 is a part that stores recording mediums 9 on which images are to be formed and feeds the recording mediums 9 to a predetermined position of the image forming unit 2.

The predetermined position of the first exemplary embodiment is the secondary transfer position TP2 of the intermediate transfer section 30.

The medium feed section 40 includes a storage body 41 that stores a plurality of recording mediums 9, a sending device 43 that sends out the recording mediums 9 one by one from the storage body 41, and the like. A loading plate on which the recording mediums 9 are to be loaded is disposed in the storage body 41.

The recording medium 9 is a medium which is transported to the image forming unit 2, onto which a toner image as an unfixed image is transferred, and on which the toner image can be held. A medium such as a sheet cut to a predetermined size is used as the recording medium 9.

A plurality of sets of the storage body 41 and the sending device 43 may be provided.

A medium transport passage Rt illustrated in FIG. 1 by a one-dot chain line is disposed in the housing 10.

The medium transport passage Rt includes a feed transport unit Rt1, a relay transport passage Rt2, a discharge transport passage Rt3, and the like.

The feed transport unit Rt1 includes a predetermined number of pairs of transport rollers 45a, 45b, and 45c, a transport guide member (not shown), and the like.

The relay transport passage Rt2 is formed of a suction-type belt transport device 46. As shown in FIG. 2 and the like, the belt transport device 46 includes a suction device 46c. In the belt transport device 46, a transport belt 46a in which a plurality of suction holes are formed is wound around two support rollers 46b and is rotated in a predetermined direction. The suction device 46c sucks air from an inner peripheral surface side of the transport belt 46a to attract the recording medium 9 to an outer peripheral surface of an upper surface side of the transport belt 46a.

The discharge transport passage Rt3 is a transport passage that connects the fixing unit 50 and a discharge port 13. The discharge transport passage Rt3 is formed of a predetermined number of pairs of transport rollers 47a and 47b, a transport guide member (not shown), and the like. The discharge port 13 is an opening through which the recording medium 9 is carried out, and is provided at a predetermined position on one side surface of the housing 10.

The formation of the unfixed image on the recording medium 9 using the image forming unit 2 is performed as follows.

Here, a case where unfixed images are formed in all of the imaging units 20A, 20B, 20C, and 20D will be described.

First, in a case where a command to perform an image forming operation is received, the photosensitive drum 21 starts to rotate in a direction indicated by an arrow A in each of the imaging units 20A, 20B, 20C, and 20D of the imaging section 20.

Further, in the intermediate transfer section 30, the intermediate transfer belt 31 starts to rotate in the direction indicated by the arrow B in a case where the image forming operation is performed.

Subsequently, in each of the imaging units 20A, 20B, 20C, and 20D, the charging device 22 charges an outer peripheral surface of the photosensitive drum 21 to a predetermined surface potential.

After that, the respective exposure devices 23 performs image exposure of the respective color components, which are formed to correspond to image information, on the charged outer peripheral surfaces of the respective photosensitive drums 21. Accordingly, electrostatic latent images divided into predetermined color components (A, B, C, and D) are formed on the outer peripheral surfaces of the photosensitive drums 21, respectively.

The image information is input from an external connection device (not shown), such as an information terminal or a storage medium connected to the image forming apparatus 1.

Subsequently, the developing devices 24A, 24B, 24C, and 24D develop the electrostatic latent images, which are formed on the outer peripheral surfaces of the photosensitive drums 21, with developers having corresponding colors, respectively. Accordingly, toner images as unfixed images having the predetermined colors (A, B, C, and D) are formed on the outer peripheral surfaces of the photosensitive drums 21, respectively.

Subsequently, in each of the imaging units 20A, 20B, 20C, and 20D of the imaging section 20, the toner image formed on the photosensitive drum 21 is transferred to the intermediate transfer section 30.

Finally, in each of the imaging units 20A, 20B, 20C, and 20D, the drum cleaning device 26 cleans the outer peripheral surface of the photosensitive drum 21 from which the toner image has been transferred.

After the photosensitive drums 21 are cleaned, the imaging units 20A, 20B, 20C, and 20D of the imaging section 20 are prepared for the next imaging step.

On the other hand, in the intermediate transfer section 30, the primary transfer devices 33 sequentially primarily transfer the toner images, which are formed on the respective photosensitive drums 21, onto the outer peripheral surface of the intermediate transfer belt 31 that passes through the primary transfer positions TP1.

At this time, the intermediate transfer belt 31 transports the toner images, which are primarily transferred onto the outer peripheral surface thereof, up to the secondary transfer position TP2.

Further, in the medium feed section 40, the sending device 43 sends out a predetermined recording medium 9 from the storage body 41 toward the secondary transfer position TP2 of the intermediate transfer section 30 in accordance with a secondary transfer time. At this time, the recording medium 9 is transported to the secondary transfer position TP2 via the feed transport unit Rt1.

Subsequently, in the intermediate transfer section 30, the secondary transfer device 34 secondarily transfers the toner images from the outer peripheral surface of the intermediate transfer belt 31, which passes through the secondary transfer position TP2, onto the recording medium 9.

Finally, in the intermediate transfer section 30, the belt cleaning device 36 cleans the outer peripheral surface of the intermediate transfer belt 31 from which the toner images have been secondarily transferred.

In a case where the intermediate transfer belt 31 is cleaned, the intermediate transfer section 30 is prepared for the next transfer step.

The recording medium 9 onto which the toner images have been secondarily transferred by the intermediate transfer section 30 is transported to be introduced into the fixing unit 50 via the relay transport passage Rt2.

In the relay transport passage Rt2, the suction-type belt transport device 46 transports the recording medium 9 in a state where the recording medium 9 is sucked.

### Fixing Unit and Heating System

The fixing unit 50 is a part that heats the unfixed toner images, which are transferred onto the recording medium 9, to fix the unfixed toner images to the recording medium 9.

As shown in FIGS. 1 and 2, the fixing unit 50 is formed of a heating system 5 according to the first exemplary embodiment.

The heating system 5 that forms the fixing unit 50 is a system in which a heating-type fixing device 51, a cooling device 60, and a roller cleaning device 70 are combined.

### Fixing Device

In the fixing device 51, a first rotating body 53 including heating units 54, a second rotating body 55, and the like are disposed inside a fixing housing 52.

The fixing housing 52 is a heat-resistant structure that has an internal space and is formed in a predetermined shape. The fixing housing 52 is formed in a long shape extending in a direction perpendicular to the planes of the paper of FIG. 2 and the like.

An introduction port 52a through which the recording medium 9 is introduced and a discharge port 52b through which the recording medium 9 is discharged are formed in the fixing housing 52.

Further, an introduction guide member 56a, which extends from the introduction port 52a up to a position in front of a passage portion FN to be described later, is disposed in the fixing housing 52.

Furthermore, discharge guide members 56b and 56c, which extend from a position on a discharge side of the passage portion FN to be described later to the discharge port 52b, are disposed in the fixing housing 52.

The first rotating body 53 includes a fixing belt 531 that is wound around a pad part 532, a first heating roller 533, and a second heating roller 534 and is rotated. The first rotating body 53 of the first exemplary embodiment is a belt-shaped rotating body, so to speak.

The fixing belt 531 is an endless belt that is rotated in a direction indicated by an arrow. Further, the fixing belt 531 is rotated while being heated to a predetermined temperature by the first heating roller 533 and the second heating roller 534.

The pad part 532 is a part that supports the fixing belt 531 to allow the fixing belt 531 to pass therethrough. Furthermore, the pad part 532 is also a part that forms the passage portion FN to be described later between the fixing belt 531 and the second rotating body 55. A heating unit may be built in the pad part 532.

The first heating roller 533 and the second heating roller 534 are rollers that support the fixing belt 531 to allow the fixing belt 531 to be rotatable while being heated by the heating units 54.

The heating units 54 are units that are disposed in hollow portions of the rollers and heat the first heating roller 533 and the second heating roller 534. A heating type of the heating unit 54 is not particularly limited.

The second rotating body 55 is a pressure roller that includes a roller body part 551 and shaft parts 552 provided at both end portions of the roller body part 551. The second rotating body 55 of the first exemplary embodiment is a roller-shaped rotating body, so to speak. The roller body part 551 is a roller body formed in a cylindrical or columnar shape, and is made of metal or the like.

Further, the second rotating body 55 is in contact with an outer peripheral surface of the fixing belt 531, which is the first rotating body 53, to form the passage portion FN through which an object to be heated passes. The object to be heated in the first exemplary embodiment is the recording medium 9 on which the toner images, which are unfixed images, are formed. The passage portion FN can also be referred to as a fixing nip that fixes the unfixed images to the recording medium 9 by heating with the unfixed images and the recording medium 9 put in the fixing nip.

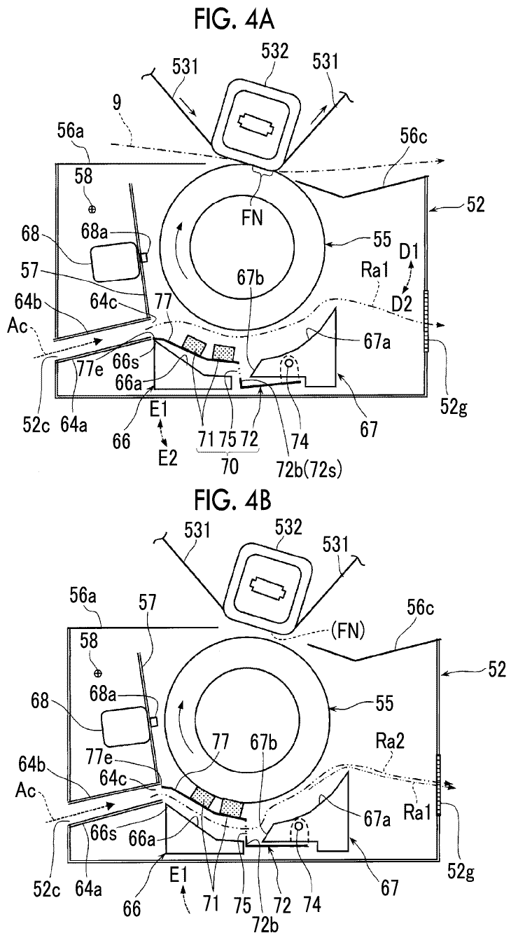

Furthermore, the second rotating body 55 is supported by a movable frame (not shown) that supports the second rotating body 55 to allow the second rotating body 55 to be in contact with and to be separated from the first rotating body 53. The movable frame oscillates with a shaft 58 of which one end portion is disposed at a predetermined position as a fulcrum, and moves up and down in directions indicated by arrows D1 and D2 (see FIGS. 4A and 4B, and the like).

Accordingly, the second rotating body 55 forms the passage portion FN in a case where the second rotating body 55 moves up in the direction indicated by the arrow D1 and is in contact with the first rotating body 53. On the other hand, the second rotating body 55 causes the passage portion FN to disappear and is opened in a case where the second rotating body 55 moves down in the direction indicated by the arrow D2 and is separated from the first rotating body 53.

In addition, the second rotating body 55 receives a pressure, which is applied from a pressure mechanism (not shown), via the movable frame. For example, a spring mechanism or a cam mechanism is applied as the pressure mechanism.

Accordingly, the second rotating body 55 is in contact with the first rotating body 53 with a predetermined pressure.

Further, for example, the first heating roller 533 and the second rotating body 55 of the fixing device 51 receive rotational power from a rotary drive device (not shown) and are rotationally driven in the direction indicated by the arrow. Accordingly, in the fixing device 51, the fixing belt 531 and the like are also rotated in the direction indicated by the arrow.

The fixing of the unfixed images using the fixing device 51 is performed as follows.

First, in the fixing device 51, the pressure roller, which is the second rotating body 55, is in contact with the fixing belt 531, which is the first rotating body 53, to form the passage portion FN in a case where the image forming operation is performed.

Subsequently, in the fixing device 51, the pressure roller, which is the second rotating body 55, starts to rotate in the direction indicated by the arrow. Further, the fixing belt 531, which is the first rotating body 53, is heated via the first heating roller 533 and the second heating roller 534. Further, the fixing belt 531, which is the first rotating body 53, receives the rotational power of the pressure roller and is rotated in the direction indicated by the arrow.

Subsequently, the recording medium 9 on which the toner images as the unfixed images are formed is introduced into the fixing device 51 via the relay transport passage Rt2. The recording medium 9 at this time is transported by the suction-type belt transport device 46 after the secondary transfer, and is introduced into the passage portion FN from the introduction port 52a.

In a case where the recording medium 9 is introduced into and passes through the passage portion FN, the fixing device 51 heats the toner images under pressure to fix the toner images to the recording medium 9.

The recording medium 9 to which the toner images are fixed is carried out from the fixing device 51 and is then transported via the discharge transport passage Rt3. Further, the recording medium 9 at this time is discharged from the discharge port 52b of the fixing housing 52 to a discharge storage part (not shown). The discharge storage part is formed of, for example, a plate-like member including a storage surface.

### Cooling Device

The cooling device 60 is a device that cools an outer peripheral surface of the pressure roller, which is the second rotating body 55, by allowing air to pass by in contact with the outer peripheral surface of the pressure roller.

Here, during the image forming operation, the outer peripheral surface of the pressure roller is rotated while being in contact with the outer peripheral surface of the first rotating body 53, which is rotated in a heated state, at the passage portion FN. That is, the outer peripheral surface of the pressure roller may be excessively heated due to direct conduction of heat from the first rotating body 53, particularly in a case where the recording medium 9 does not pass through. For this reason, the outer peripheral surface of the pressure roller needs to be cooled by the cooling device 60 and to be maintained at a temperature equal to or lower than a predetermined surface temperature.

As shown in FIG. 2 and the like, the cooling device 60 of the first exemplary embodiment includes a blower 61, an exhaust device 65, passage forming members 66 and 67, a temperature measuring unit 68, and the like.

The blower 61 includes a blower housing 62, blower fans 63, and a blower duct 64. Further, the blower 61 is disposed such that the blower housing 62 and the blower fans 63 face a lower portion of a side surface portion of the fixing housing 52 in which the introduction port 52a is provided.

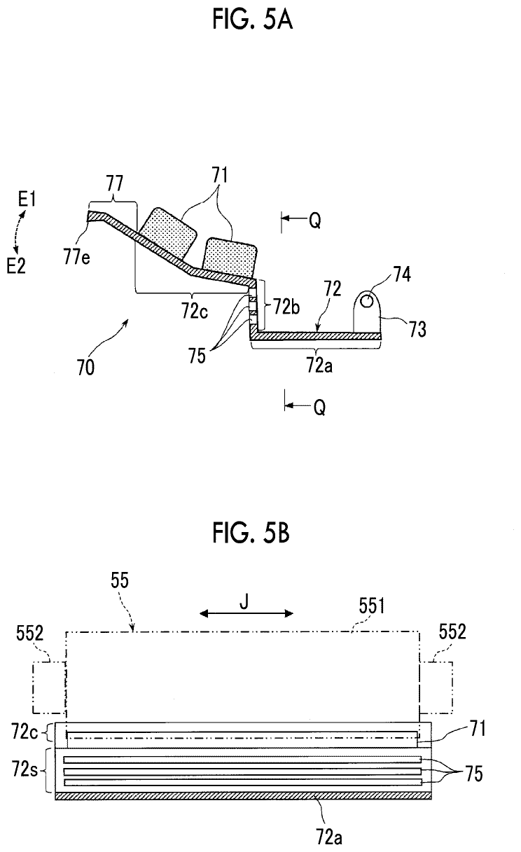

The blower housing 62 is a structure that has an internal space in which the blower fans 63 are disposed and is formed in a predetermined shape. The blower housing 62 is formed in a long shape extending in the direction perpendicular to the planes of the paper of FIG. 2 and the like. The direction perpendicular to the planes of the paper of FIG. 2 and the like is a direction parallel to an axial direction J (FIG. 5B) of the pressure roller that is the second rotating body 55. Further, the direction perpendicular to the planes of the paper of FIG. 2 and the like is also a depth direction of the fixing device 51.

Furthermore, the blower housing 62 is provided with an intake port and an exhaust port (not shown). The blower housing 62 is disposed such that the exhaust port thereof is connected to a blower inlet 52c of the fixing housing 52. Air of which the temperature is lower than the temperature of high-temperature air in the fixing housing 52 is taken into the intake port.

The blower fan 63 is a fan that generates air Ac for cooling the outer peripheral surface of the pressure roller which is the second rotating body 55. A plurality of blower fans 63 are disposed along the axial direction J of the pressure roller which is the second rotating body 55.

The blower duct 64 is a duct that guides the air Ac generated by the blower fans 63 to blow the air to the outer peripheral surface of a lower portion of the pressure roller.

A passage space, which faces the outer peripheral surface of the lower portion of the pressure roller from the exhaust port of the blower housing 62, is formed in the blower duct 64. Reference numeral 64a in FIGS. 4A and 4B denotes a duct-lower surface portion that forms a lower surface portion of the passage space, and reference numeral 64b denotes a duct-upper surface portion that forms an upper surface portion of the passage space.

Further, a blowing port 64c is provided at an end portion of the blower duct 64 in front of the outer peripheral surface of the lower portion of the pressure roller. The blowing port 64c is formed as a substantially rectangular opening that is long along the axial direction J of the pressure roller.

In the fixing device 51, a partition plate 57 is disposed inside the fixing housing 52 as shown in FIGS. 4A and 4B and the like.

The partition plate 57 is disposed from an upper side portion of the blowing port 64c of the blower duct 64 up to a predetermined position beyond the temperature measuring unit 68. Further, the partition plate 57 is disposed with a predetermined interval from the outer peripheral surface of the pressure roller.

The exhaust device 65 is formed of an exhaust duct and an exhaust fan (not shown).

Further, the exhaust device 65 is disposed to face a lower portion of a side surface portion of the fixing housing 52 in which the discharge port 52b is provided. An exhaust port 52g is provided at the lower portion of the side surface portion of the fixing housing 52.

The exhaust duct is disposed to connect the exhaust port 52g of the fixing housing 52 to an exhaust port (not shown) provided in a back portion or the like of the housing 10 of the image forming apparatus 1.

The exhaust fan operates to suck and discharge the air in the fixing housing 52 (mainly the air Ac sent by the blower 61). Further, the exhaust fan is disposed at a predetermined position on a downstream side in a direction in which the air in the exhaust duct flows.

The passage forming members 66 and 67 are members forming a passage (space) that allows the air Ac sent from the blower 61 to flow along a circumferential direction of the outer peripheral surface of the pressure roller which is the second rotating body 55.

The passage forming members 66 and 67 form a major portion of a path Ra1 which will be described later and along which the air Ac flows to pass in contact with the outer peripheral surface of the pressure roller. The path Ra1 is a path in a case where the air Ac for cooling flows, as illustrated in FIGS. 2 and 4A by a two-dot chain line arrow.

The passage forming members 66 and 67 are disposed to face an outer peripheral surface portion of a lower portion of the pressure roller, which is opposite to the first rotating body 53, with a predetermined interval from the outer peripheral surface portion.

The passage forming members 66 are disposed at a position close to the blower 61 with a boundary near a lower end of the outer peripheral surface of the pressure roller. The passage forming members 67 are disposed at a position close to the exhaust device 65 with a boundary near the lower end of the outer peripheral surface of the pressure roller.

The passage forming members 66 and 67 are disposed near the lower end of the outer peripheral surface of the pressure roller with a gap therebetween in the axial direction J of the pressure roller.

Further, as shown in FIGS. 4A and 4B, passage forming surface 66a and 67a are formed on the passage forming members 66 and 67, respectively.

The passage forming surface 66a is a surface having a shape that is bent from a lower side portion of the blowing port 64c of the blower duct 64 to a vicinity of the lower end of the outer peripheral surface of the pressure roller. An upstream end portion 66s of the passage forming surface 66a is located at a height position substantially identical to the height position of the lower side portion of the blowing port 64c of the blower duct 64 (see FIGS. 4A and 4B). The passage forming surface 67a is a surface having a shape that is curved from the vicinity of the lower end of the outer peripheral surface of the pressure roller to a vicinity of a middle.

Both the passage forming surfaces 66a and 67a are also surfaces extending along the axial direction J of the pressure roller.

The temperature measuring unit 68 is a unit for measuring a surface temperature of the outer peripheral surface of the pressure roller that is the second rotating body 55.

The temperature measuring unit 68 is disposed at a position near the downstream side of the position of the passage portion FN of the pressure roller in a rotation direction. In other words, the temperature measuring unit 68 is disposed in a range between the position of the passage portion FN and the blower duct 64 of the cooling device 60.

Further, the temperature measuring unit 68 is disposed in a state where a detection portion 68a (see FIGS. 4A and 4B) thereof penetrates the partition plate 57 toward the pressure roller. The detection portion 68a is in a state where the detection portion 68a faces the outer peripheral surface of the pressure roller with a certain interval therebetween.

Furthermore, the temperature measuring unit 68 is adapted to measure the surface temperature of the outer peripheral surface of the pressure roller at a plurality of predetermined locations in the axial direction J. The plurality of predetermined locations are, for example, both end portions and a middle portion of the outer peripheral surface of the pressure roller in the axial direction J.

Information on the measurement results of the temperature measuring unit 68 is used to control the operation of the cooling device 60.

Cooling using the cooling device 60 is performed as follows.

Incidentally, the cooling device 60 operates during the image forming operation and during the cleaning of the second rotating body 55, which is the pressure roller.

In a case where the image forming operation is performed, the blower 61 of the cooling device 60 operates to generate the air Ac for cooling as shown in FIG. 2 and the like.

The cooling device 60 blows this air Ac to a lower region of the outer peripheral surface of the pressure roller, which is rotationally driven in the direction indicated by the arrow, from the blower duct 64.

Further, the cooling device 60 causes the blown air Ac to flow along the path Ra1 for cooling, which allows the air Ac to pass to be in contact with the outer peripheral surface of the pressure roller, and then causes the air Ac to be sucked into the exhaust duct of the exhaust device 65.

Specifically, as shown in FIG. 4A, the air Ac from the blower 61 is blown out from the blowing port 64c of the blower duct 64.

The blown air Ac flows to pass through a first passage that is formed between the outer peripheral surface of the pressure roller and the passage forming surfaces 66a of the passage forming members 66. After that, the air Ac flows to pass through a second passage that is formed between the outer peripheral surface of the pressure roller and the passage forming surfaces 67a of the passage forming members 67.

The air Ac having passed through the second passage is sucked by a suction force of the exhaust device 65. The air Ac at this time flows such that the air Ac passes through the exhaust port 52g of the fixing housing 52 and is sucked into the exhaust duct of the exhaust device 65.

Accordingly, the cooling device 60 can cool the outer peripheral surface of the pressure roller since the air Ac flowing through each of the passages passes in contact with the outer peripheral surface of the pressure roller. That is, the cooling device 60 is a device that cools the outer peripheral surface of the pressure roller by generating forced convection in which air passes in contact with the outer peripheral surface of the pressure roller.

Further, the cooling device 60 efficiently cools the pressure roller by causing the air Ac to flow in a direction opposite to the rotation direction of the pressure roller.

Furthermore, the cooling device 60 is adapted such that the air volume or the like of the blower 61 is controlled in accordance with information on the measurement results of the temperature measuring unit 68.

### Roller Cleaning Device

The roller cleaning device 70 is a device that cleans the outer peripheral surface of the pressure roller which is the second rotating body 55.

As shown in FIG. 2 and the like, the roller cleaning device 70 of the first exemplary embodiment includes cleaning members 71, a support member 72, and the like.

The cleaning members 71 are members that are in contact with the outer peripheral surface of the pressure roller to clean the outer peripheral surface in a case where cleaning is performed.

The cleaning members 71 of the first exemplary embodiment are formed of two square bar-like cleaning members extending along the axial direction J of the pressure roller.

The support member 72 is a member that supports the cleaning members 71 to allow the cleaning members 71 to be in contact with and separated from the outer peripheral surface of the pressure roller.

As shown in FIG. 5A, the support member 72 is formed of a plate-like member that includes at least a body portion 72a, a standing surface portion 72b, and a mounting surface portion 72c. Further, as shown in FIG. 5B, the support member 72 is a plate-like member that has a shape extending in the axial direction J of the pressure roller.

The body portion 72a is a portion having a flat plate-like form. The body portion 72a is provided with a mounting protrusion 73 at an end portion thereof opposite to the standing surface portion 72b. The mounting protrusion 73 is mounted on a shaft 74, which is disposed in the fixing housing 52 or a part of the passage forming members 67, to be rotationally movable.

Further, the body portion 72a of the first exemplary embodiment is disposed to be present below the passage forming members 67.

The standing surface portion 72b is a portion that protrudes substantially vertically upward from an end portion of the body portion 72a opposite to the mounting protrusion 73. Further, the standing surface portion 72b is also a flat plate-like portion that stands up close to the outer peripheral surface of the pressure roller.

The standing surface portion 72b is formed to stand up from the body portion 72a by a predetermined height. Furthermore, the standing surface portion 72b of the first exemplary embodiment stands up to pass through a gap between the passage forming member 66 and the passage forming member 67.

The mounting surface portion 72c is a portion on which the cleaning members 71 are mounted and held.

The mounting surface portion 72c is formed as a plate-like portion that extends from an upper end of the standing surface portion 72b to a side opposite to the body portion 72a. The mounting surface portion 72c is formed as a portion that extends to be bent obliquely upward from the upper end of the standing surface portion 72b substantially along the outer peripheral surface of the pressure roller.

The mounting surface portion 72c of the first exemplary embodiment is disposed to be present above the passage forming members 66.

The two cleaning members 71 are mounted on the upper surface of the mounting surface portion 72c to be fixed at a predetermined interval.

The support member 72 is disposed to be in the following state.

The support member 72 is disposed in a state where the standing surface portion 72b passes through a gap between the passage forming member 66 and the passage forming member 67.

The support member 72 is disposed such that the mounting protrusion 73 is present below the passage forming members 67. The support member 72 is disposed such that the mounting surface portion 72c is present above the passage forming members 66.

Further, the support member 72 oscillates with the shaft 74 as a fulcrum and is movable up and down as indicated by arrows E1 and E2. The support member 72 is moved up and down using the power of a drive device (not shown).

Then, in a case where cleaning is performed, the support member 72 is moved in a direction indicated by the arrow E1 up to a cleaning position where the cleaning members 71 are in contact with the outer peripheral surface of the pressure roller as shown in FIG. 4B.

The support member 72 moved to this cleaning position is mainly in a state where the standing surface portion 72b enters the path Ra1 and blocks the path Ra1.

For this reason, the standing surface portion 72b of the support member 72 serves as a portion that blocks the path Ra1 in a case where the cleaning members 71 are in contact with the outer peripheral surface of the pressure roller. That is, the support member 72 has a shape having a blocking portion 72s that blocks the path Ra1.

Strictly speaking, the mounting surface portion 72c of the support member 72 moved to the cleaning position enters the path Ra1 together with the cleaning members 71 to block the path Ra1.

On the other hand, in a case where cleaning is not performed, the support member 72 is moved in a direction indicated by the arrow E2 up to a predetermined retracted position where the cleaning members 71 are separated from the outer peripheral surface of the pressure roller.

The support member 72 moved to the retracted position is in a state where the mounting surface portion 72c thereof is close to the passage forming surface 66a of the passage forming member 66.

Cleaning using the roller cleaning device 70 is performed as follows.

First, in a case where cleaning is performed in the roller cleaning device 70, the support member 72 is moved in the direction indicated by the arrow E1 with the shaft 74 as a fulcrum (see FIG. 4B).

Accordingly, the cleaning members 71 are in a state where the cleaning members 71 are in contact with the outer peripheral surface of the pressure roller, which is the second rotating body 55. The cleaning members 71 at this time are in contact with a portion of the outer peripheral surface of the pressure roller that faces the passage forming surfaces 66a of the passage forming members 66.

Then, during this cleaning, the pressure roller is rotationally driven in a direction indicated by an arrow. A rotation direction at this time is identical to that during the image forming operation. A rotation speed is identical to or different from a rotation speed during the image forming operation.

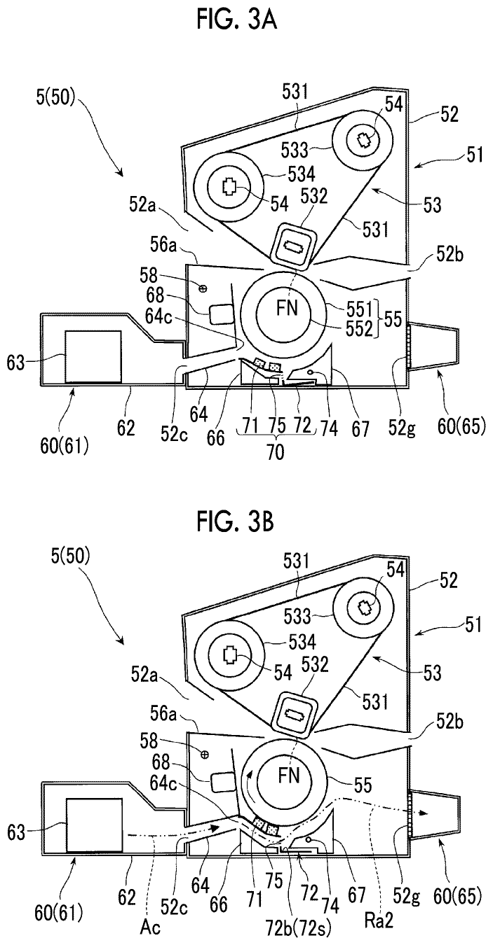

Further, during this cleaning, the pressure roller is in a state where the pressure roller is separated from the fixing belt 531, which is the first rotating body 53, before the cleaning of the pressure roller (see FIG. 3A). In a case where the pressure roller is separated before the cleaning of the pressure roller, for example, the rotation of the pressure roller is stopped.

Accordingly, the roller cleaning device 70 causes the cleaning members 71 to be in contact with the outer peripheral surface of the pressure roller that is rotationally driven in the direction indicated by the arrow. As a result, the roller cleaning device 70 removes unnecessary matter, such as paper dust, adhering to the outer peripheral surface of the pressure roller to clean the outer peripheral surface.

In the roller cleaning device 70 having completed the cleaning, the support member 72 is moved in the direction indicated by the arrow E2 with the shaft 74 as a fulcrum. Accordingly, the cleaning members 71 are in a state where the cleaning members 71 are separated from the outer peripheral surface of the pressure roller, which is the second rotating body 55 (see FIG. 3A).

(Problem in a Case where the Second Rotating Body During Cleaning is Cooled)

Meanwhile, in a case where the pressure roller, which is the second rotating body 55, is cooled by the cooling device 60 during the cleaning, there is the following problem in the heating system 5 that forms the fixing unit 50.

The reason why the pressure roller is cooled during the cleaning is that it is necessary to cool the pressure roller even during the cleaning.

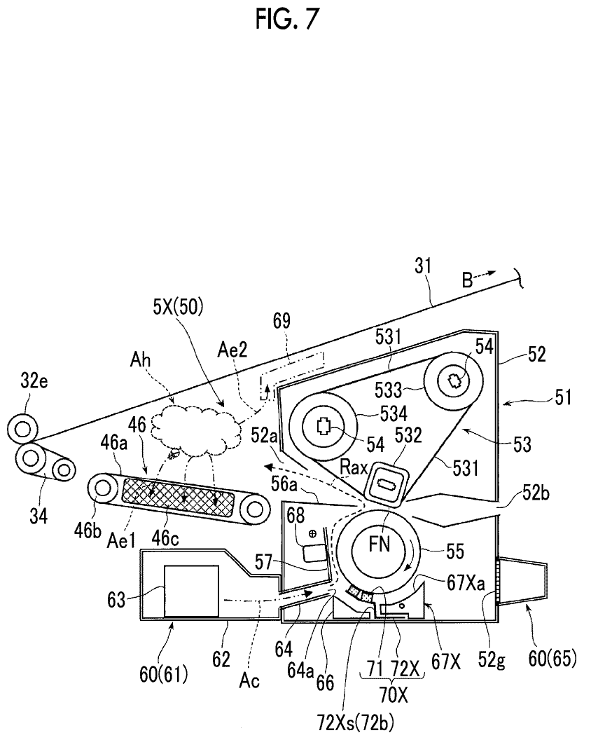

Here, the problem will be described on the basis of a heating system 5X as a comparative example illustrated in FIG. 7.

The heating system 5X has a configuration identical to the configuration of the heating system 5 according to the first exemplary embodiment, except that a roller cleaning device 70X for comparison is applied.

The roller cleaning device 70X for comparison is different from the roller cleaning device 70 of the first exemplary embodiment in the following points. That is, the roller cleaning device 70X is different from the roller cleaning device 70 in that a support member 72X for comparison of which a standing surface portion 72b is a blocking portion 72Xs is applied.

The fact that the standing surface portion 72b is the blocking portion 72Xs means that the standing surface portion 72b is adapted to enter and block the path Ra1 during cleaning.

Reference numeral 67X in FIG. 7 denotes a downstream passage forming member, and reference numeral 67Xa denotes a passage forming surface of the passage forming member 67X.

First, the heating system 5X operates the cooling device 60 in a case where the roller cleaning device 70X causes the cleaning members 71 to be in contact with the outer peripheral surface of the pressure roller to clean the outer peripheral surface of the pressure roller.

In this case, in the heating system 5X, the standing surface portion 72b, which is the blocking portion 72Xs of the support member 72X, is in a state where the standing surface portion 72b closes a front position of the second passage formed between the outer peripheral surface of the pressure roller and the passage forming members 67 to block the second passage. The second passage is also a part (downstream portion) of a major portion of a predetermined path Ra1 for cooling (see FIG. 2 and the like) during the image forming operation.

Accordingly, in the heating system 5X, air Ac generated by the blower 61 of the cooling device 60 cannot pass in the middle of the path Ra1 for cooling and hardly flows.

On the other hand, the air Ac at this time flows in the fixing housing 52 along an unexpected path Rax illustrated by a broken line with an arrow in FIG. 7.

This unexpected path Rax is a path along which the air Ac rises and moves in the rotation direction of the pressure roller from the blowing port 64c of the blower duct 64 at first.

Specifically, in the path Rax, at first, the air Ac blows out from the blowing port 64c and then moves to rise through a gap between the partition plate 57 and the pressure roller.

Subsequently, in the path Rax, the air Ac passes through a gap between the introduction guide member 56a and the pressure roller and then flows out to the outside of the fixing housing 52 from the introduction port 52a of the fixing housing 52.

Then, the air Ac having flowed out to the outside of the fixing housing 52 flows into a closed space, which is also a part of a peripheral portion of the fixing housing 52, and is temporarily accumulated. The closed space is a space that is surrounded by the intermediate transfer belt 31, the secondary transfer device 34, and the belt transport device 46. The closed space may also be a location that is away from the predetermined path Ra1 for cooling.

Since the air Ac at this time flows in contact with the outer peripheral surface of the pressure roller in the first stage of the path Rax, the air Ac receives heat and is heated to a high temperature.

For this reason, high-temperature air Ah is accumulated in the closed space. Further, since this high-temperature air Ah is accumulated in the housing 10 of the image forming apparatus 1, a temperature in the housing 10 rises.

Incidentally, the heating system 5X in this case may be adapted such that the suction-type belt transport device 46 is operated. In this case, a part Ae1 of the high-temperature air Ah accumulated in the closed space is suctioned by the belt transport device 46 and is exhausted to the outside of the image forming apparatus 1.

Further, an exhaust duct 69 may be disposed in the heating system 5X as illustrated in FIG. 7 by a two-dot chain line. This exhaust duct 69 is disposed above the fixing housing 52 of the fixing device 51 and exhausts the high-temperature air generated in the fixing housing 52. In this case, a part Ae2 of the high-temperature air Ah is sucked into the exhaust duct 69 and is exhausted to the outside of the image forming apparatus 1.

However, in the heating system 5X, a material or a component that is likely to be adversely affected by high-temperature air may be present in the closed space. In other words, a material or a component of which heat resistance is lower than the heat resistance of other surrounding materials or components may be present in the closed space. Examples of the material include toner and the like. Examples of the component include the secondary transfer belt 34a of the secondary transfer device 34 and the intermediate transfer belt 31.

That is, in this case, the material or the component is exposed to unexpected high-temperature air.

As a result, a material such as toner present on the secondary transfer belt 34a, the intermediate transfer belt 31, the recording medium 9, and the like may be melted, deteriorate, or the like. Further, for example, filming may occur on the secondary transfer belt 34a or the intermediate transfer belt 31.

The filming is a problem in which unnecessary matter adhering to the surface of the secondary transfer belt 34a or the intermediate transfer belt 31 is fixed to the surface of the belt due to an increase in temperature. The unnecessary matter is residual toner, paper dust, or the like.

The problem occurring due to exposure to such high-temperature air is likely to be induced by the following factors.

For example, the problem may be induced by a factor in which the amount of heat generated from the first rotating body 53 of the fixing device 51 is increased to improve productivity. Further, the problem may be induced by a factor in which the secondary transfer position TP2 and the fixing device 51 are close to each other due to the high-density mounting of components.

In addition, it is conceivable to increase the air volume of the blower 61 of the cooling device 60 as a measure against the problem.

However, this measure induces a problem that noise is also increased with an increase in the air volume. Further, with this measure, the air Ac sent from the blower 61 still flows along the unexpected path Rax. That is, the problem is not addressed with this measure.

### Details of Roller Cleaning Device

Therefore, the support member 72 provided with vent holes 75 is applied to the roller cleaning device 70 in the heating system 5 according to the first exemplary embodiment.

As shown in FIGS. 3A and 3B and the like, the standing surface portion 72b that is the blocking portion 72s is provided with the vent holes 75 of the roller cleaning device 70.

The vent holes 75 are holes that are connected to the path Ra1 and allow a space to be ventilated.

The connection of the vent holes 75 to the path Ra1 means that the vent holes 75 are connected to a path portion, which is present on the downstream side of the standing surface portion 72b of the support member 72 during the cleaning, of the path Ra1.

The path portion of the first exemplary embodiment is a path that passes through the second passage formed between the outer peripheral surface of the pressure roller, which is the second rotating body 55, and the passage forming members 67. Further, the path portion also includes a path to the exhaust port 52g from the second passage.

As shown in FIG. 5A, the vent holes 75 of the first exemplary embodiment are formed as holes that extend straight to be substantially parallel to the body portion 72a of the support member 72 and penetrate the standing surface portion 72b. The vent holes 75 extend substantially horizontally in the support member 72 during the cleaning.

Further, as shown in FIG. 5B, the vent holes 75 of the first exemplary embodiment are formed as slit-like long holes that extend parallel to each other along the axial direction J of the pressure roller. The vent hole 75 formed of the long hole has a length equal to or slightly longer than a length of the roller body part 551 in the axial direction J. The length of the roller body part 551 in the axial direction J corresponds to a width of the outer peripheral surface of the pressure roller.

In addition, as shown in FIGS. 5A and 5B, the vent holes 75 of the first exemplary embodiment are formed as a plurality of (for example, three) holes that are arranged at regular intervals in a vertical direction. The number of the vent holes 75 is not limited, and only one vent hole may be provided.

### Cooling During the Formation of Image

In the heating system 5 including the roller cleaning device 70, as already described, the outer peripheral surface of the pressure roller, which is the second rotating body 55, is cooled by the cooling device 60 during the image forming operation.

At this time, the support member 72 of the roller cleaning device 70 is moved in the direction indicated by the arrow E2 to separate the cleaning members 71 from the outer peripheral surface of the pressure roller (see FIG. 4A and the like).

Accordingly, the first passage (gap) is formed between the outer peripheral surface of the lower portion of the pressure roller and the support member 72 of the roller cleaning device 70. Further, the second passage (gap) is formed between the outer peripheral surface of the lower portion of the pressure roller and the passage forming members 67 in a state where the second passage is continuous with the first passage.

In the cooling device 60, the air Ac generated by the blower 61 flows along the path Ra1 for cooling (see FIG. 4A and the like).

Specifically, the air Ac blown out from the blower duct 64 flows to be sucked into the exhaust device 65 after passing through the first passage and the second passage.

As a result, the air Ac flowing along the path Ra1 passes in contact with the outer peripheral surface of the pressure roller during the image forming operation, so that the outer peripheral surface of the pressure roller is cooled. The path Ra1 at this time is a predetermined path for cooling during the image forming operation.

### Cooling During Cleaning

Further, in the heating system 5 including the roller cleaning device 70, the outer peripheral surface of the pressure roller, which is the second rotating body 55, is cooled by the cooling device 60 even during the cleaning of the outer peripheral surface of the pressure roller.

At this time, the roller cleaning device 70 is in a state where the support member 72 is moved in the direction indicated by the arrow E1 to bring the cleaning members 71 into contact with the outer peripheral surface of the pressure roller as shown in FIG. 4B.

Accordingly, a third passage (gap) is formed between the outer peripheral surface of the lower portion of the pressure roller and the passage forming members 66 with the support member 72 of the roller cleaning device 70 interposed therebetween. Further, the second passage (gap) is formed between the outer peripheral surface of the lower portion of the pressure roller and the passage forming members 67.

Here, the blocking portion 72s of the support member 72 is interposed between the third passage and the second passage.

However, the third passage and the second passage are connected to each other via the vent holes 75.

In the cooling device 60, the air Ac generated by the blower 61 flows along the path Ra2 illustrated by a two-dot chain line with an arrow in FIG. 4B.

Specifically, the air Ac blown out from the blower duct 64 flows into the third passage and then flows into the second passage through the vent holes 75 of the support member 72. Since the air Ac at this time flows into the second passage through the vent holes 75, the air Ac flows to be connected in the middle of the path Ra1 during the image forming operation. After that, the air Ac flowed into the second passage flows to be sucked into the exhaust device 65.

As a result, the air Ac flowing along the path Ra2 passes in contact with the outer peripheral surface of the pressure roller during the cleaning, so that the outer peripheral surface of the pressure roller is cooled. The path Ra2 at this time is a path for cooling during the cleaning.

From the above, in the heating system 5, the cooling device 60 can cause the air Ac to flow into a predetermined path Ra1 to cool the outer peripheral surface of the pressure roller even during the cleaning of the outer peripheral surface of the pressure roller, which is the second rotating body 55.

Accordingly, in the fixing device 51 of the heating system 5, the surface temperature of the pressure roller can be stably maintained at a temperature equal to or lower than a predetermined temperature. As a result, in the fixing device 51, there is no concern that the pressure roller excessively heats the recording medium 9 at the passage portion FN.

### Other Configurations

In the heating system 5, the support member 72 of the roller cleaning device 70 is provided with a suppression portion 77 as shown in FIGS. 4A and 5A.

The suppression portion 77 is a portion that suppresses the flow of the air Ac, which is generated by the cooling device 60, to a location away from the path Ra2 during the cleaning of the pressure roller.

The location away from the path Ra2 in the first exemplary embodiment is a location other than a location from the blowing port 64c of the blower duct 64 to the outer peripheral surface of the lower portion of the pressure roller. Specifically, the location away from the path Ra2 is a location facing upward from a gap between the blowing port 64c of the blower duct 64 and the pressure roller.

The suppression portion 77 is formed as a portion that extends from an end of the mounting surface portion 72c for the cleaning members 71 to a side opposite to the body portion 72a (see FIG. 5A).

Specifically, the suppression portion 77 is formed as a portion that is put in a gap between the end of the mounting surface portion 72c of the support member 72 and the upper side portion of the blowing port 64c in a case where the cleaning members 71 are moved to the cleaning position (see FIG. 4B).

That is, the suppression portion 77 is present to close the gap in a case where the support member 72 moves the cleaning members 71 to the cleaning position.

Further, a distal end 77e of the suppression portion 77 is close to or is in contact with the lower side portion of the blowing port 64c in a case where the cleaning members 71 are moved to the retracted position (see FIG. 4A). On the other hand, the distal end 77e of the suppression portion 77 is close to or is in contact with the upper side portion of the blowing port 64c in a case where the cleaning members 71 are moved to the cleaning position (see FIG. 4B).

In the heating system 5, the flow of the air Ac, which is generated by the cooling device 60, to a location away from the path Ra2 is suppressed as compared to a case where the support member 72 is not provided with the suppression portion 77. In other words, the flow of the air Ac along the unexpected path Rax (see FIG. 7) through the gap during the cleaning of the pressure roller in the heating system 5X of the comparative example is suppressed in the heating system 5.

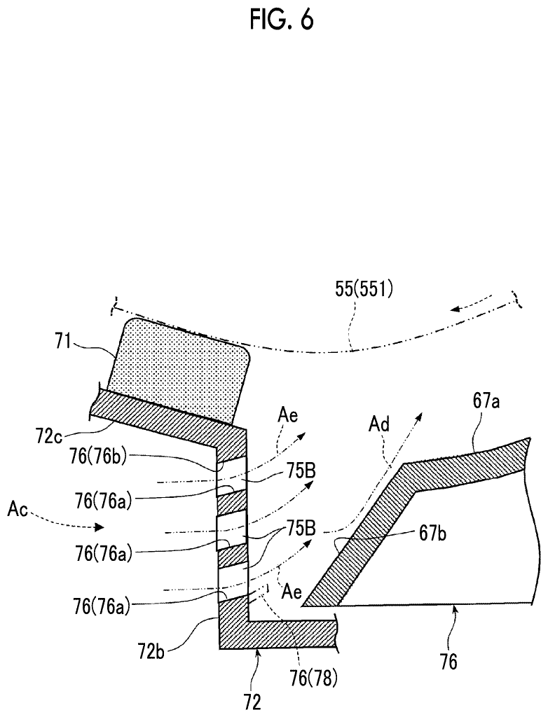

Further, in the heating system 5, as shown in FIGS. 4A and 6, each passage forming member 67 of the cooling device 60 is provided with a guide surface 67b.

The guide surface 67b is a surface that guides the air Ac, which has passed through the vent holes 75 of the support member 72 of the roller cleaning device 70, to allow the air Ac to flow toward the outer peripheral surface of the pressure roller.

The guide surface 67b is formed as an inclined surface that is inclined at an upstream end portion of the passage forming member 67 to be close to the outer peripheral surface of the pressure roller (see FIGS. 4A and 4B and the like). Specifically, the guide surface 67b is formed of an inclined surface that is formed at an end portion of the passage forming member 67 facing the vent holes 75 and is inclined upward from a lower end thereof at a predetermined angle to intersect with the passage forming surface 67a.

In the heating system 5, a part of the air Ac having passed through the vent holes 75 advances to come into contact with the guide surfaces 67b. The air Ac at this time is guided to the guide surfaces 67b and flows toward the outer peripheral surface of the pressure roller as illustrated by a two-dot chain line Ad with an arrow in FIG. 6.

For this reason, in the heating system 5, the air Ac having passed through the vent holes 75 can easily flow toward the outer peripheral surface of the pressure roller as compared to a case where the guide surface 67b is not formed of the inclined surface.

### Modification Examples

The present invention is not limited to the configuration illustrated as the first exemplary embodiment. That is, the present invention can have various modifications or improvements without changing the gist of each invention described in the claims.

The present invention also includes, for example, a modification example to be described below.

As shown in FIG. 6, vent holes 75B provided with guide portions 76 may be applied as the vent holes 75 of the support member 72 of the roller cleaning device 70.

The guide portion 76 is a portion that guides the air Ac, which is generated by the cooling device 60, to allow the air Ac to flow toward the outer peripheral surface of the pressure roller.

The guide portion 76 illustrated in FIG. 6 is formed of inclined surfaces 76a and 76b inclined such that an inner wall surface of the vent hole 75B is close to the outer peripheral surface of the pressure roller. The inclined surface 76a is an inner wall surface that is inclined on a lower side of the vent hole 75B. The inclined surface 76b is an inner wall surface that is inclined on an upper side of the vent hole 75B.

In the heating system 5 in this case, in a case where the air Ac generated by the cooling device 60 passes through the vent holes 75B, the air Ac is guided by the inclined surfaces 76a and 76b of the guide portion 76. Accordingly, the air Ac passes through the vent holes 75B and then flows toward the outer peripheral surface of the pressure roller as illustrated by two-dot chain lines Ae with arrows in FIG. 6.

Therefore, in the heating system 5 in this case, the cooling device 60 easily cools the outer peripheral surface of the pressure roller with the air Ac, which has passed through the vent holes 75B, as compared to a case where the vent holes 75B do not include the guide portions 76.

Further, in the heating system 5 in this case, the air Ac passing through the vent holes 75B can be easily made to flow toward the outer peripheral surface of the pressure roller as compared to a case where the guide portion 76 is not formed of the inclined surfaces 76a and 76b.

As illustrated in FIG. 6 by a two-dot chain line, a guide plate 78 provided on a downstream side (outlet side) of the vent hole 75B may be employed as the guide portion 76.

The guide plate 78 illustrated in FIG. 6 is provided together with the inclined surface 76a of the vent hole 75B. However, the guide plate 78 may be provided on the downstream side (outlet side) of the vent hole 75 (see FIG. 5A) that is not provided with the inclined surface 76a.

Even in a case where the guide plate 78 is provided, the air Ac passing through the vent holes 75B or the vent holes 75 can be easily made to flow toward the outer peripheral surface of the pressure roller.

The vent holes 75 and 75B provided in the support member 72 of the roller cleaning device 70 are not limited to a series of (slit-like) long holes illustrated in first exemplary embodiment. For example, a plurality of holes formed in a predetermined opening shape to be uniformly present may be applied as other vent holes 75 and 75B.

The passage forming members 66 and 67 of the cooling device 60 are not limited to a configuration where the passage forming members 66 and 67 are formed of members separate from the fixing housing 52. For this reason, the passage forming members 66 and 67 may be changed to a shape in which a part (bottom surface portion) of the fixing housing 52 is formed as passage forming portions.

In the fixing device 51 of the heating system 5 according to the first exemplary embodiment, a rotating body having a roller form may be applied as the first rotating body 53. Examples of the rotating body having a roller form include a heating roller.

The heating system 5 forming the fixing unit 50 has been exemplified in first exemplary embodiment, but the heating system according to the exemplary embodiment of the present invention is not limited thereto. In the heating system 5 according to the first exemplary embodiment, the recording medium 9 on which unfixed images are formed is used as an object to be heated.

The heating system according to the exemplary embodiment of the present invention may be, for example, a heating system that uses a substrate coated with powdered paint as an object to be heated and heats the powdered paint to fix the powdered paint to the substrate.

The heating system in this case includes a first rotating body 53, a second rotating body 55, a cooling device 60, a roller cleaning device 70, and the like. Rotating bodies having a roller form, or the like are used as the first rotating body 53 and the second rotating body 55 at this time.

Further, in the first exemplary embodiment, a unit including the imaging section 20 and the intermediate transfer section 30 has been exemplified as the image forming unit 2 of the image forming apparatus 1.

However, the configuration of the image forming unit 2 of the image forming apparatus 1 according to the exemplary embodiment of the present invention is not particularly limited, and may be an image forming apparatus that requires the fixing unit 50 consisting of the heating system 5.

The imaging section 20 is not limited to an imaging section that consists of four imaging units 20A, 20B, 20C, and 20D. Further, the number of the imaging units may be any number other than four or may be one. Furthermore, the image forming unit 2 may not include the intermediate transfer section 30.

Alternatively, the upper housing 10A and the lower housing 10B of the image forming apparatus 1 may be independent separate bodies and may be connected to each other during use.

Further, the medium feed section 40 of the image forming apparatus 1 may be a medium feed device that is separate from the image forming apparatus 1 and is connected to the image forming apparatus 1 in a case where the medium feed device is used.

Furthermore, the discharge storage part of the image forming apparatus 1 may be a post-processing device that also has a function of performing predetermined post-processing on the recording medium 9.

### Supplementary Note

(((1)))

A heating system comprising:
a first rotating body that is heated by a heating unit and is rotated;
a second rotating body that is rotated while being in contact with an outer peripheral surface of the first rotating body to form a passage portion through which an object to be heated passes;
a cooling device that causes air to flow along a path, which allows the air to pass in contact with an outer peripheral surface of the second rotating body, to cool the outer peripheral surface; and
a support member that supports a cleaning member, which is to be in contact with the outer peripheral surface of the second rotating body to clean the outer peripheral surface, to allow the cleaning member to be in contact with and separated from the outer peripheral surface and includes a blocking portion entering and blocking the path in a case where the cleaning member is in contact with the outer peripheral surface,
wherein the blocking portion of the support member is provided with a vent hole that is connected to the path.
   (((2)))

The heating system according to (((1))),
wherein the vent hole includes a guide portion that guides the air to allow the air to flow toward the outer peripheral surface of the second rotating body.
   (((3)))

The heating system according to (((2))),
wherein the guide portion is formed of an inclined surface that is inclined close to the outer peripheral surface of the second rotating body.
   (((4)))

The heating system according to any one of (((1))) to (((3))),
wherein the support member includes a suppression portion that suppresses a flow of the air to a location away from the path during cleaning of the second rotating body.
   (((5)))

The heating system according to (((4))),
wherein a material or a component that is likely to be adversely affected by high-temperature air is present at the location away from the path.
   (((6)))

The heating system according to any one of (((1))) to (((5))), further comprising:
a passage forming member that is disposed to face a portion of the outer peripheral surface of the second rotating body, which overlaps with the path, and forms a passage allowing the air to flow along a circumferential direction of the outer peripheral surface,
wherein the passage forming member includes a guide surface that guides air, which has passed through the vent hole, to allow the air to flow toward the outer peripheral surface of the second rotating body.
   (((7)))

The heating system according to (((6))),
wherein the guide surface is formed of an inclined surface that is inclined close to the outer peripheral surface of the second rotating body.
   (((8)))

The heating system according to any one of (((1))) to (((7))),
wherein the object to be heated is a recording medium on which an unfixed image is formed.
   (((9)))

An image forming apparatus comprising:
an image forming unit that forms an unfixed image on a recording medium; and
a fixing unit that heats the unfixed image to fix the unfixed image to the recording medium,
wherein the fixing unit is formed of the heating system according to any one of (((1))) to (((7))).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A heating system comprising:
a first rotating body that is heated by a heating unit and is rotated;
a second rotating body that is rotated while being in contact with an outer peripheral surface of the first rotating body to form a passage portion through which an object to be heated passes;
a cooling device that causes air to flow along a path, which allows the air to pass in contact with an outer peripheral surface of the second rotating body, to cool the outer peripheral surface; and
a support member that supports a cleaning member, which is to be in contact with the outer peripheral surface of the second rotating body to clean the outer peripheral surface, to allow the cleaning member to be in contact with and separated from the outer peripheral surface and includes a blocking portion entering and blocking the path in a case where the cleaning member is in contact with the outer peripheral surface,
wherein the blocking portion of the support member is provided with a vent hole that is connected to the path.

2. The heating system according to claim 1,
wherein the vent hole includes a guide portion that guides the air to allow the air to flow toward the outer peripheral surface of the second rotating body.

3. The heating system according to claim 2,
wherein the guide portion is formed of an inclined surface that is inclined close to the outer peripheral surface of the second rotating body.

4. The heating system according to claim 1,
wherein the support member includes a suppression portion that suppresses a flow of the air to a location away from the path during cleaning of the second rotating body.

5. The heating system according to claim 4,
wherein a material or a component that is likely to be adversely affected by high-temperature air is present at the location away from the path.

6. The heating system according to claim 1, further comprising:
a passage forming member that is disposed to face a portion of the outer peripheral surface of the second rotating body, which overlaps with the path, and forms a passage allowing the air to flow along a circumferential direction of the outer peripheral surface,
wherein the passage forming member includes a guide surface that guides air, which has passed through the vent hole, to allow the air to flow toward the outer peripheral surface of the second rotating body.

7. The heating system according to claim 6,
wherein the guide surface is formed of an inclined surface that is inclined close to the outer peripheral surface of the second rotating body.

8. The heating system according to claim 1,
wherein the object to be heated is a recording medium on which an unfixed image is formed.

9. The heating system according to claim 2,
wherein the object to be heated is a recording medium on which an unfixed image is formed.

10. The heating system according to claim 3,
wherein the object to be heated is a recording medium on which an unfixed image is formed.

11. The heating system according to claim 4,
wherein the object to be heated is a recording medium on which an unfixed image is formed.

12. The heating system according to claim 5,
wherein the object to be heated is a recording medium on which an unfixed image is formed.

13. The heating system according to claim 6,
wherein the object to be heated is a recording medium on which an unfixed image is formed.

14. The heating system according to claim 7,
wherein the object to be heated is a recording medium on which an unfixed image is formed.

15. An image forming apparatus comprising:
an image forming unit that forms an unfixed image on a recording medium; and
a fixing unit that heats the unfixed image to fix the unfixed image to the recording medium,
wherein the fixing unit is formed of the heating system according to claim 1.

16. An image forming apparatus comprising:
an image forming unit that forms an unfixed image on a recording medium; and
a fixing unit that heats the unfixed image to fix the unfixed image to the recording medium,
wherein the fixing unit is formed of the heating system according to claim 2.

17. An image forming apparatus comprising:
an image forming unit that forms an unfixed image on a recording medium; and
a fixing unit that heats the unfixed image to fix the unfixed image to the recording medium,
wherein the fixing unit is formed of the heating system according to claim 3.

18. An image forming apparatus comprising:
an image forming unit that forms an unfixed image on a recording medium; and
a fixing unit that heats the unfixed image to fix the unfixed image to the recording medium,
wherein the fixing unit is formed of the heating system according to claim 4.

19. An image forming apparatus comprising:
an image forming unit that forms an unfixed image on a recording medium; and
a fixing unit that heats the unfixed image to fix the unfixed image to the recording medium,
wherein the fixing unit is formed of the heating system according to claim 5.

20. An image forming apparatus comprising:
an image forming unit that forms an unfixed image on a recording medium; and
a fixing unit that heats the unfixed image to fix the unfixed image to the recording medium,
wherein the fixing unit is formed of the heating system according to claim 6.
